(19) United States
(12) Patent Application Publication
(10) Pub. No.: US 2015/0192284 A1
(43) Pub. Date: Jul. 9, 2015

(54) LED Light Bulb with Removable LED Portion

(71) Applicant: Dan Steinberg, Blacksburg, VA (US)

(72) Inventor: Dan Steinberg, Blacksburg, VA (US)

(21) Appl. No.: 14/148,643

(22) Filed: Jan. 6, 2014

(51) Int. Cl. F21V 23/06; F21V 29/00; F21V 14/00; F21K 99/00

(52) U.S. Cl. CPC F21V 23/06; F21K 9/13; F21V 29/22; F21V 29/26; F21V 14/00; F21V 29/004

(57) ABSTRACT

Provided is an LED light bulb with separable top and bottom portions. The top portion comprises LED lamps and the bottom portion comprises a power electronics circuit for powering the LED lamps. The top and bottom portions are electrically and mechanically connected by connectors. When connected, there is a gap between the top and bottom portions. A heat sink is disposed in the gap. A hole can be present in the top portion, and the hole can be fluidically connected to the gap, thereby provided improved heat dissipation. There can be multiple ways of connecting the top and bottom portions, with each way of connecting providing a different type of light output.

### RELATED APPLICATIONS

The present application claims the benefit of priority from provisional patent application 61/848,474 filed on Jan. 4, 2013, which is hereby incorporated by reference.

### FIELD OF THE INVENTION

The present invention relates generally to lighting devices, and in particular to a light-emitting diode light bulb with separable LED lamp and power supply portions.

### BACKGROUND OF THE INVENTION

Present LED light bulbs have several limitations and critical design requirements:

1) the LEDs must be kept cool to assure adequate lifetime. Effective heat sinking is critical.

2) bulb life must be very long to provide a good value for the consumer. The reliability of the power electronics is critical for long bulb life because power electronics is often the cause of bulb failure.

3) present bulbs only offer fixed colors (e.g. different color temperatures or colors).

4) failure in only the power electronics, or only the LED lamps cannot be easily tested by the consumer. Hence, repairable lamps are discarded.

5) improvements in LED technology are available only by buying completely new bulbs.

6) the edison bulb shape tends to minimize surface area (i.e. is a low surface area to volume ratio shape), increasing difficulty of adequate heat dissipation in warm environments.

7) LED lamps cannot have long heat sink fins or fingers on the outer surface of the lamp, because they will interfere with fixtures, become tangled, and can be broken or apply excessive force to the LED lamps or LED circuitboard. For these reasons, LED lamps typically have smooth, low-profile heat sinks on the outer surface, which limits heat dissipation, and adversely effects LED lamp life.

Accordingly, there is a need for an LED light bulb with improved heat dissipation and modular construction that allows a consumer to replace only the LED portion or only the power electronics portion. Also, there is a need for an LED light bulb that allows a consumer to select a desired color or color temperature.

### SUMMARY

The present invention provides an LED light bulb with a top portion and a bottom portion. The top portion contains LED lamps and a connector for connecting to the bottom portion. The bottom portion contains power supply electronics. The top portion and bottom portion are separated by a gap through which air can flow. Preferably, the gap is open along an entire circumference of the gap. The top portion also comprises a heat sink in thermal contact with the LED lamps. The heat sink can have fins, fingers or other features that extend into the gap.

Optionally, the top portion and bottom portion are detachable.

A vent hole can be present in the top portion or the bottom portion. The vent hole is fluidically connected to the gap and allows convective air flow when the light bulb is oriented vertically.

The gap can be about ¼-¾″ wide for example.

In a preferred embodiment, the top portion containing the LED lamps has a male connector (e.g. pins or plugs) that extends across the gap.

Also, there can be multiple ways of connecting the top portion and bottom portion, with each way providing a different type of light output.

### DESCRIPTION OF THE FIGURES

FIG. 1 shows a cross sectional side view of an assembled LED light bulb according to the present invention.

FIG. 2 shows a cross sectional side view of a disassembled LED light bulb according to the present invention.

FIG. 3 shows a light bulb according to the present invention in operation, and a cross sectional view of a gap and heat sink.

FIG. 4A shows a square heat sink suitable for use in a light bulb according to the present invention.

FIG. 4B shows a heat sink with a radial fin pattern suitable for use in a light bulb according to the present invention.

FIG. 5 shows a light bulb according to the present invention with a vent hole in the top portion.

FIG. 6 shows a light bulb according to the present invention with a second heat sink for cooling the power supply electronics.

FIG. 7 shows a light bulb according to the present invention with heat dissipating fins on an exterior surface of the bottom portion.

FIG. 8 shows a possible circuit diagram for a light bulb according to the present invention.

FIGS. 9A-9D illustrate an embodiment in which the top portion and bottom portion can be connected in three different ways, with each way providing a different type of light output.

FIG. 10 shows an embodiment with a vent hole in the bottom portion.

FIG. 11 shows an embodiment where the gap has a nonuniform thickness.

### DETAILED DESCRIPTION

The present invention provides a light emitting diode (LED) light bulb having a separable top portion containing LED lamps, and a bottom portion containing power supply electronics. A gap is present between the top portion and bottom portion. The top and bottom can optionally be completely separated, which allows users to swap different LED lamps and power supply electronics. A heat sink element is disposed in the gap between the top and bottom portions. Because the heat sink is not disposed on an outer surface, the heat sink can comprise conventional fins, fingers or other shapes for heat dissipation. Also, the top (LED) portion can have a vent hole (fluidically connected to the gap) for convective air flow. Also, the top and bottom portions can be connected in multiple ways (i.e. the bottom portion can have multiple sets of connectors), with each way providing a different type of light output (e.g. color or color temperature). The present LED light bulb provides user-selectable color choices, improved heat dissipation, and interchangeable LED and power electronics.

FIG. 1 shows a light bulb according to an embodiment of the present invention. The light bulb has a top portion 20, a bottom portion 22, and a gap 24 between the top and bottom portions. The top portion 20 comprises a cover (or lens) 26 covering light emitting diodes (LEDs) 28. The LEDs 28 are mounted on a circuitboard 30. A heat sink 32 is present in the gap 24 and in thermal contact with the LEDs 28. Also, the heat sink 32 can be in direct contact with the LEDs 28 and circuitboard 30. The heat sink 32 preferably (but optionally) comprises fingers 34 (or fins) that extend into the gap 24.

The bottom portion 22 comprises power supply electronics 36 and a base 38. The power supply electronics can include an AC-DC converter, DC-DC converters, wireless control electronics, or other electronic circuits for controlling or converting electrical power applied to the LEDs 28. The base 38 can be an edison base (as shown) or a bayonet base, for example.

The cover 26 can be liquid-filled, as known in the art, and can be made out of plastic, glass or any other transparent material. The cover 26 can have phosphors for converting light colors, or reflecting elements (not shown) for distributing light, as known in the art.

The gap 24 does not include a solid portion 40 of the heat sink. The gap 24 comprises the space between the top portion 20 and bottom portion 22 that is partially filled with air. The gap can be about 0.030″-1.5″ for example. Typically, the gap will be about ¼″-¾″ wide, but the present invention and appended claims are not so limited.

Preferably, the gap 24 is open to ambient along the entire circumference of the light bulb. Also optionally, and heat sink 32 is contained within the gap 24 and does not extend outside the plane of the gap 24.

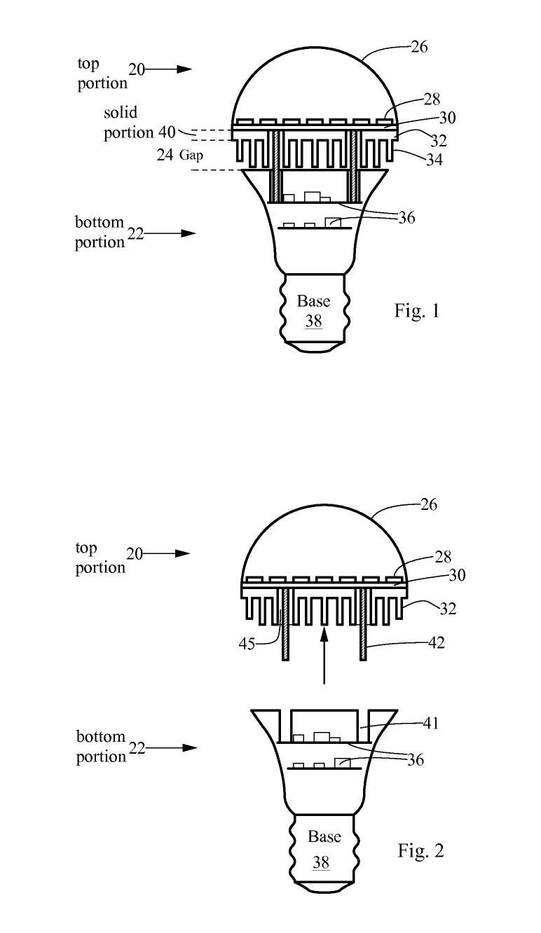

FIG. 2 shows a cross sectional side view with the top portion 20 and bottom portion 22 separated.

The bottom portion 22 has a first connector 41 for engaging with second connectors 42 in the top portion 20. The connectors 41 42 provide both electrical connectivity and mechanical attachment between the top portion 20 and bottom portion 22. There must be at least 2 connectors to complete an electrical circuit, of course. For improved mechanical attachment and stability, preferably the connectors are spaced apart as shown, but they can also be next to each other. In the specific embodiment illustrated in FIGS. 1 and 2, the second connector comprises a pin or metal plug, and the first connector comprises a female receptacle that tightly engages the pin or metal plug (i.e. by friction). Additional connectors can be present that do not provide electrical connectivity, for improved mechanical attachment.

The connectors 41 42 can comprise pins, plugs or other connectors in any shape or configuration. For example, the second connectors can comprise round pins or rectangular or square plugs. The connectors 41 42 can be covered with a plastic housing, or can comprise bare metal.

A space 45 between the second connectors 42 and the heat sink 32 can be filled with insulating adhesive, resin other material for preventing bending or damage to the connectors 42.

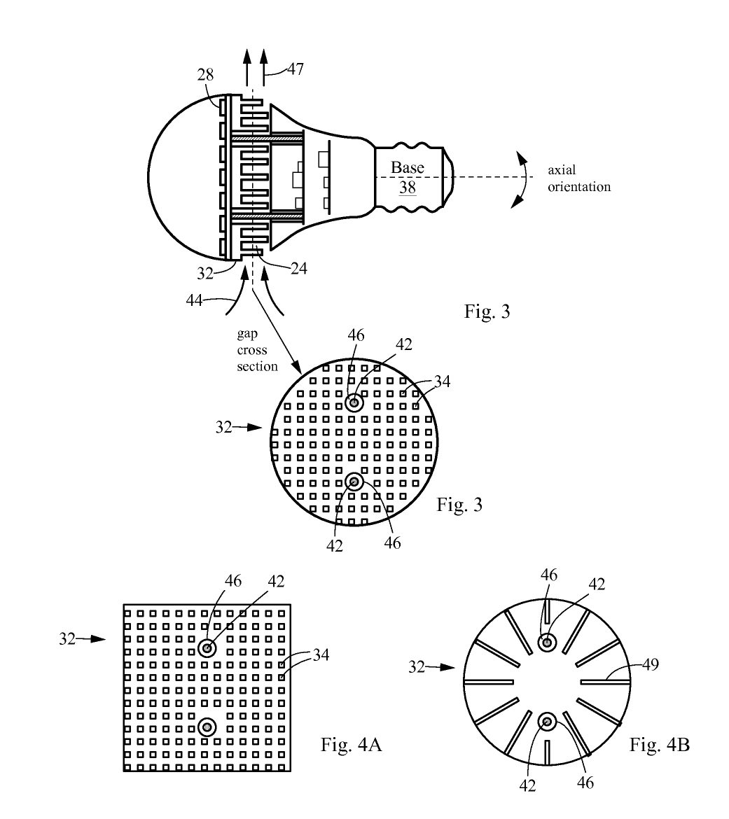

FIG. 3 shows the LED light bulb in operation and oriented horizontally, and shows a cross section through the gap 24. During operation, heat from the LEDs 28 flows into the heat sink 32 and fingers 34. Cool ambient air 44 enters at the bottom of the gap 24, rises through the gap 24, and exits the gap as warm air 47. Because the heat sink has 1-dimensional fingers 34, air convection can occur for any axial orientation of the light bulb. Consequently, the light bulb of FIG. 3 facilitates efficient heat removal from the LEDs when oriented horizontally.

The heat sink 32 has holes 46 to accommodate the second connector 42.

FIG. 4A shows a square or rectangular heat sink. In some embodiments, the light bulb is square or rectangular in cross section, thereby facilitating the use of inexpensive extruded aluminum heat sinks that do not require cutting of circular sections.

FIG. 4B shows a heat sink with radial fins 49. Radial fins 49 will allow air flow through the gap when the light bulb is oriented horizontally (with any axial orientation) as shown in FIG. 3.

It is noted that the fingers 34 or fins 49 are optional in the invention. The heat sink 32 can comprise a flat, smooth sheet of heat conductive material such as aluminum plate for example.

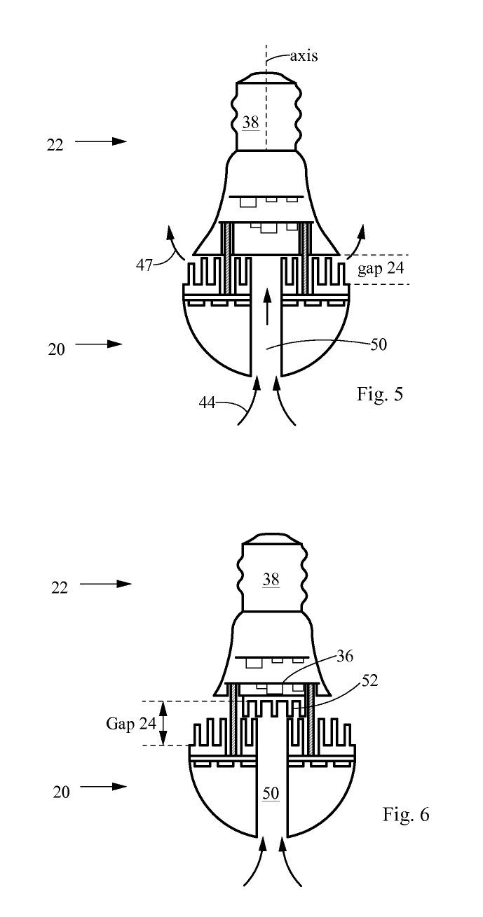

FIG. 5 shows an embodiment having a vent hole 50 in the top portion 20. The vent hole 50 is fluidically connected to the gap 24. Consequently the vent hole 50 facilitates convection of air through the gap when the light bulb is oriented vertically as shown. The vent hole 50 can be in the center (i.e. along the axis) of the light bulb as shown, or can be displaced to the side. Also, multiple holes can be present (all fluidically connected to the gap 24), or only a single hole can be present (as shown). The vent hole 50 can be a circular hole, about ⅛″-1″ in diameter, for example.

The vent hole 50 and gap 24 are fluidically connected internally to the light bulb, so that convective air flow is possible through the interior of the light bulb.

FIG. 6 shows am embodiment having a second heat sink 52 attached to the bottom portion 22. The second heat sink 52 is in thermal contact with the power supply electronics 36. The second heat sink 52 is disposed in the gap 24.

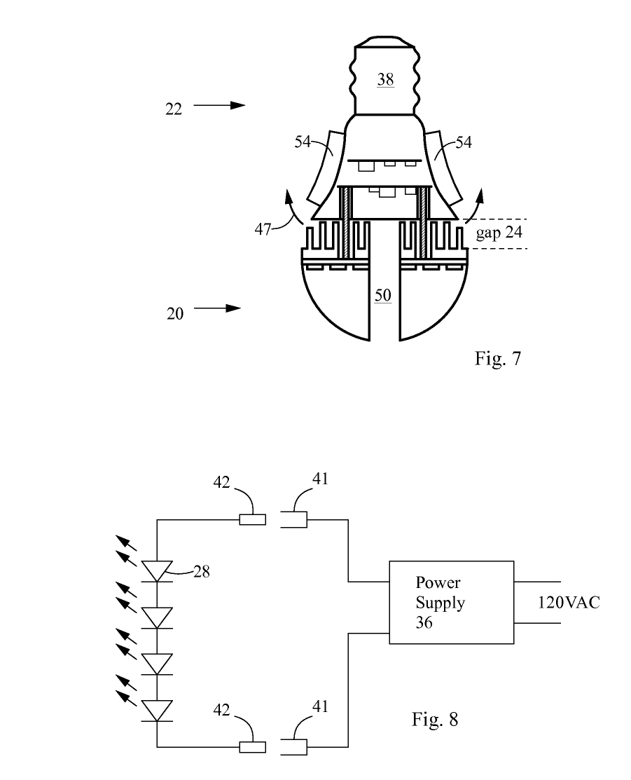

FIG. 7 shows an embodiment in which heat dissipating fins 54 are disposed on an exterior surface of the bottom portion 22.

FIG. 8 shows a possible electrical circuit diagram of a light bulb according to the present invention. The circuit of FIG. 8 is merely exemplary and can be changed in many ways in the invention. For example, some control electronics (e.g. a circuit for pulsing the LEDs or providing time-varying colors) can be present in the top portion.

In another aspect of the invention, there are multiple ways of connecting the top portion 20 and bottom portion 22. Each way of connecting will provide a different type of light output. Consequently, the user can select a preferred color or light operating mode. For example, one way of connecting the portions 20 22 can provide cool white light, another way can provide warm light, another way can provide strobe light, and another way can provide other colors or other lighting modes.

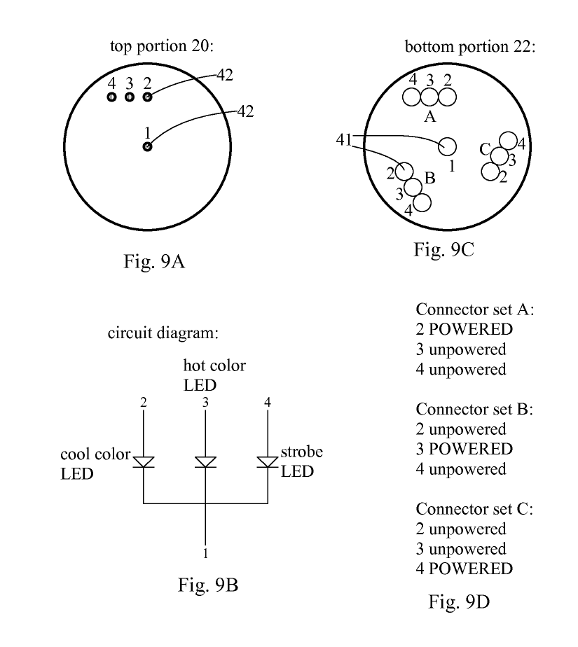

FIGS. 9A-9C shows a specific implementation of a multi-mode light bulb.

FIG. 9A shows the arrangement of second connectors 42 on the top portion. Connectors are labeled 1, 2, 3, 4.

FIG. 9B shows a specific circuit diagram for LEDs connected to the first connectors 42. Connector 42-1 is the ground connection.

FIG. 9C shows a bottom portion with three sets of first connectors 41-1,2,3,4 (sets A, B and C). Each of the sets A, B C can engage with the connectors 42-1,2,3,4 There are three possible ways to connect the top portion and bottom portion. Each way of connecting the top portion and bottom portion will power a different set of LEDs and thereby provide a different type of light output. Connector 41-1 is the ground connector and is connected for every possible orientation.

FIG. 9D shows a list of a possible power configurations for the first connectors 41 in the bottom portion 22. With connectors 42 inserted in the “A” set connectors 41, only LED #2 will be powered, providing a cool color. Similarly, with connectors 42 inserted into the “B” set connectors 41, only LED #3 will be powered, providing a hot color. And if connectors 42 are inserted into the “C” set connectors 41, only LED #3 will be powered, providing a strobe light effect.

Connector 42-1 and connector 41-1 will be connected, for any of the three orientations.

Also, it is noted that the connectors 41 on the bottom portion can provide different voltage levels, or power functions. For example, the strobe (i.e. pulsing) function can be provided by the power electronics 36 in the bottom portion 22 instead of by the LEDs in the top portion 20.

In the present specification and appended claims, “multiple” means 2 or more (ways of connecting the top portion and bottom portion). For example, there can be 2, 4, 5, 6 or more different ways of attaching the top portion an bottom portion, with each way providing a different type of light output.

In this way, the present LED light bulb can provide a user with a variety of lighting effects that are easily selectable by detaching and reattaching the top portion and bottom portion.

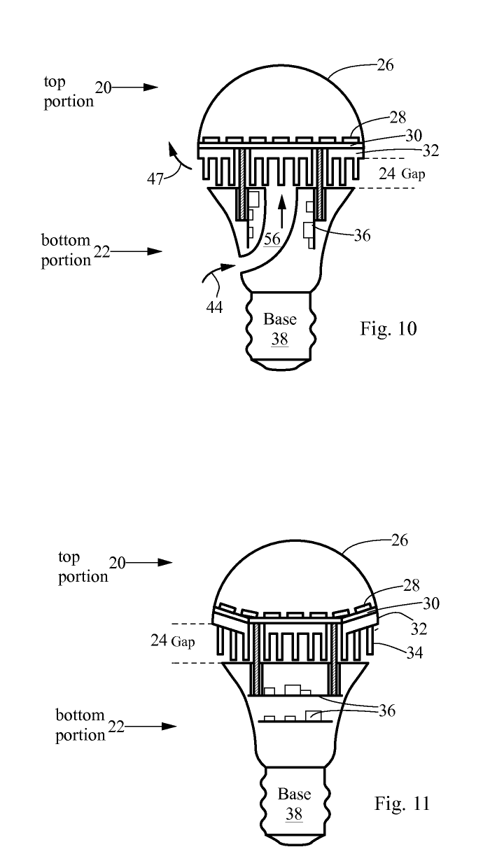

FIG. 10 shows an embodiment having a vent hole 56 in the bottom portion 22. The vent hole 56 is fluidically connected to the gap 24 and it facilitates convective air flow when the light bulb is oriented vertically as shown. Since the vent hole is in the bottom portion 22, more space is available for LEDs 28 in the top portion 20.

FIG. 11 shows an embodiment in which the gap 24 has a nonuniform thickness. Specifically, the gap 24 is wider near the outer surface of the light bulb.

It is noted that the gap 24 does not need to be planar. For example, the gap 24 can alternatively have a conical shape or curved shape.

Since the LED lamps and power electronics are separable in the present invention, a user can easily troubleshoot the lamp to determine if a fault is present in the LED lamps or in the power supply circuit. The power supply circuit, which has a higher failure rate, is easily replaced at lower cost than replacing the entire lamp. Also, a user can purchase various colors of LED lamps without having to purchase an entire lamp. For example, the top portion can be made to provide warm or cool white illumination, and various color temperatures. For parties and special occasions, flashing or colored LED top portions can be used. Since the LED lamps are attached by pins or plugs, they can be easily and quickly changed. And of course changing the type of lamp does not require purchasing an entire new bulb unit-only the LED top portion is required.

The above embodiments may be altered in many ways without departing from the scope of the invention. Accordingly, the scope of the invention should be determined by the following claims and their legal equivalents.

What is claimed is:

1. An LED light bulb, comprising:
1) a bottom portion comprising:
a) a power supply circuit;
b) a first detachable electrical connector electrically connected to the power supply circuit, and for providing electrical power;
2) a top portion comprising:
a) a LED lamp circuit;
b) a second detachable electrical connector electrically connected to the LED lamp circuit, for connecting to the first electrical connector and for receiving electrical power;
3) a heat sink attached to the top portion and in thermal contact with the LED lamp circuit; wherein the top portion and the bottom portion are separated by a gap when connected, wherein the heat sink is disposed in the gap, and wherein the top portion and bottom portion are detachable.

2. The LED light bulb of claim 1 wherein the heat sink comprises heat dissipating fingers or fins disposed in the gap.

3. The LED light bulb of claim 1 further comprising a vent hole extending through the top portion, wherein the vent hole is fluidically connected to the gap internally to the light bulb.

4. The LED light bulb of claim 1 further comprising a vent hole extending through the bottom portion, wherein the vent hole is fluidically connected to the gap internally to the light bulb.

5. The LED light bulb of claim 1 wherein the gap has a thickness in the range of 1/16 to 1.5 inches.

6. The LED light bulb of claim 1 wherein the second connector comprises a male pin or plug and the second connector extends across the gap.

7. The LED light bulb of claim 1 wherein the top portion comprises a transparent cover for covering the LEDs, wherein the LEDs are disposed between the cover and the heat sink.

8. The LED light bulb of claim 1 further comprising a second heat sink disposed in the gap, wherein the second heat sink is thermally connected to the power supply circuit.

9. The LED light bulb of claim 1 wherein the first electrical connector comprises female receptacles, and the second electrical connector comprises a male connector.

10. The LED light bulb of claim 1 wherein the LED circuit comprises multiple LED types, and the bottom portion has multiple sets of first connectors, whereby there are multiple ways to connect the top portion and the bottom portion, and wherein each of the multiple ways provides a different type of light output.

11. An LED light bulb, comprising:
1) a bottom portion comprising:
a) a power supply circuit;
b) a first detachable electrical connector electrically connected to the power supply circuit, and for providing electrical power;
2) a top portion comprising:
a) a LED lamp circuit;
b) a second detachable electrical connector electrically connected to the LED lamp circuit, for connecting to the first electrical connector and for receiving electrical power;
3) a heat sink attached to the top portion and in thermal contact with the LED lamp circuit; wherein the top portion and the bottom portion are separated by a gap when connected, wherein the heat sink is disposed in the gap, wherein the top portion and bottom portion are detachable and wherein the LED circuit comprises multiple LED types, and the bottom portion has multiple sets of first connectors, whereby there are multiple ways to connect the top portion and the bottom portion, and wherein each of the multiple ways provides a different type of light output.

12. The LED light bulb of claim 11 wherein the heat sink comprises heat dissipating fingers or fins disposed in the gap.

13. The LED light bulb of claim 11 further comprising a vent hole extending through the top portion, wherein the vent hole is fluidically connected to the gap internally to the light bulb.

14. The LED light bulb of claim 11 further comprising a vent hole extending through the bottom portion, wherein the vent hole is fluidically connected to the gap internally to the light bulb.

15. The LED light bulb of claim 11 wherein the gap has a thickness in the range of 1/16 to 1.5 inches.

16. The LED light bulb of claim 11 wherein the second connector comprises a male pin or plug and the second connector extends across the gap.

17. The LED light bulb of claim 11 wherein the top portion comprises a transparent cover for covering the LEDs, wherein the LEDs are disposed between the cover and the heat sink.

18. The LED light bulb of claim 11 further comprising a second heat sink disposed in the gap, wherein the second heat sink is thermally connected to the power supply circuit.

19. The LED light bulb of claim 11 wherein the first electrical connector comprises female receptacles, and the second electrical connector comprises male connectors.
